(19) United States
(12) Patent Application Publication
(10) Pub. No.: US 2009/0318177 A1
(43) Pub. Date: Dec. 24, 2009

(54) METHOD AND APPARATUS FOR LTE SYSTEM INFORMATION UPDATE IN CONNECTED MODE

(75) Inventors: Peter S. Wang, E. Setauket, NY (US); Guodong Zhang, Syosset, NY (US); Jin Wang, Central Islip, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/393,285

(22) Filed: Feb. 26, 2009

Related U.S. Application Data
(60) Provisional application No. 61/032,271, filed on Feb. 28, 2008.

(51) Int. Cl. H04B 7/00

(52) U.S. Cl. 455/515

(57) ABSTRACT

A method and apparatus for a wireless transmit receive unit (WTRU) to receive system information updates. This includes the WTRU aligning a discontinuous reception (DRX) on-duration with a system information update cycle such that the system information update cycle is a multiple of a DRX cycle.

### CROSS REFERENCE TO RELATED APPLICATION

This application claims the benefit of U.S. provisional application No. 61/032,271 filed Feb. 28, 2008 which is incorporated by reference as if fully set forth.

### FIELD OF INVENTION

This application is related to wireless communications.

### BACKGROUND

A goal of the Third Generation Partnership Project (3GPP) Long Term Evolution (LTE) program is to bring new technology, new architecture and new methods into the field of wireless communications, and to provide improved spectral efficiency, reduced latency, and better utilization of radio resources, thereby providing faster user experiences and richer applications and services with less associated cost.

In an LTE communication system, a wireless transmit receive unit (WTRU) may be in communication with an e Node-B (eNB). One of the ways the eNB can inform the WTRU about operating parameters is for the eNB to transmit system information to the WTRU. System information is public information about how a WTRU communicates with a cell, such as transmission bandwidth, channel configurations, cell loading and power control parameters, for example.

There may be a relatively large amount of system information transmitted by an eNB in a cell. Therefore, in order to organize the transmission of the system information, the information may be divided into a number of system information blocks (SIBs). The types of the system information carried in a particular SIB is constant, but the value of the information carried in each SIB is subject to change.

Due to the large variety of types of system information in the SIBs, the process of informing a WTRU that system information has changed could be chaotic if not properly scheduled. Scheduling is complicated, however, by the many different predicted rates of change of each of the various types of system information in the SIBs. For example, the cell transmission bandwidth may be a static parameter for an eNB, and may not change at all, while a parameter relating to power control, for example, may change at a comparatively fast pace. Therefore, a single schedule of system information updates is not possible, due to the highly variable rate of change of the system information.

In general, rates of change of system information may fall into three groups; static, semi-static and dynamic. System information parameters that may be considered static and that seldom change may include operating parameters for an eNB, such as the cell transmission bandwidth and the number of transmit/receive antennas, for example. These parameters may be broadcast by an eNB in a master information block (MIB), for example. Semi-static parameters may include, for example, the SIB scheduling information, common channel configurations and neighbor cell lists. Semi-static parameters may be transmitted in particular SIBs, such as SIB-1 and SIB-2, for example. Dynamic parameters may include, for example, uplink interference, cell loading factors or the cell access restriction information. The validity of these information elements may last from a few LTE frames to a dozen LTE frames, and may change very fast.

The system information change indication is communicated to the whole cell and the WTRUs operating in it by a notification, or a paging message, with a special indicator. In order for a WTRU to obtain the change indication, and learn the new system information, the WTRU needs to operate in the same system information change notification cycle as the eNB. The WTRU should be synchronized to a particular time period or the notification cycle, when a system information change notification indication may occur. On the other hand, the system information update may be synchronized with another timing period called a modification period (MP). A WTRU will receive a system information update notification in a first MP, and in the next MP the WTRU will receive all the updated content. The MP is a multiple of a system information change cycle. However, while this method may be used for static operating parameters and the semi-static parameters in the SIBS, due to the fast pace of the change of certain other dynamic parameters; their update notification may use different mechanisms.

To further complicate matters, a WTRU may be functioning in an idle state (no activity) or an active state (active communication with an eNB). When a WTRU is in idle state, it may receive system updates in paging messages transmitted by an eNB. However, when a WTRU is in active state, it may be actively monitoring a downlink channel, such as a physical downlink control channel (PDCCH), for example, for system updates. Therefore, active mode WTRUs and idle mode WTRUs may also have different procedures for receiving a system information change notification.

### SUMMARY

A method and apparatus is disclosed for a wireless transmit receive unit (WTRU) to receive system information updates. The method may include the WTRU aligning a discontinuous reception (DRX) on-duration with a system information notification cycle. The WTRU may be configured to receive the updates, receive a notification of the updates, and align the DRX on-duration with the notification cycle.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of WTRUs and an eNB in accordance with one embodiment;

FIG. 2 is a functional block diagram of a WTRU and the eNB of FIG. 1 in accordance with one embodiment

FIG. 3 shows a method for system information (SI) updates in accordance with one embodiment; and

FIG. 4 shows a method for SI updates with an offset in accordance with another embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

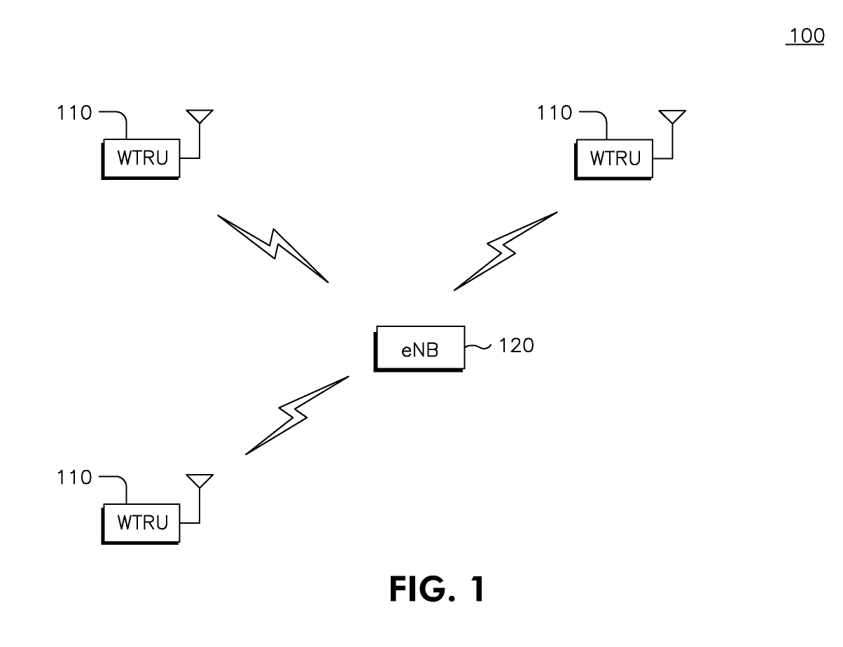

FIG. 1 shows a wireless communication system 100 including a plurality of WTRUs 110 and an eNB 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100.

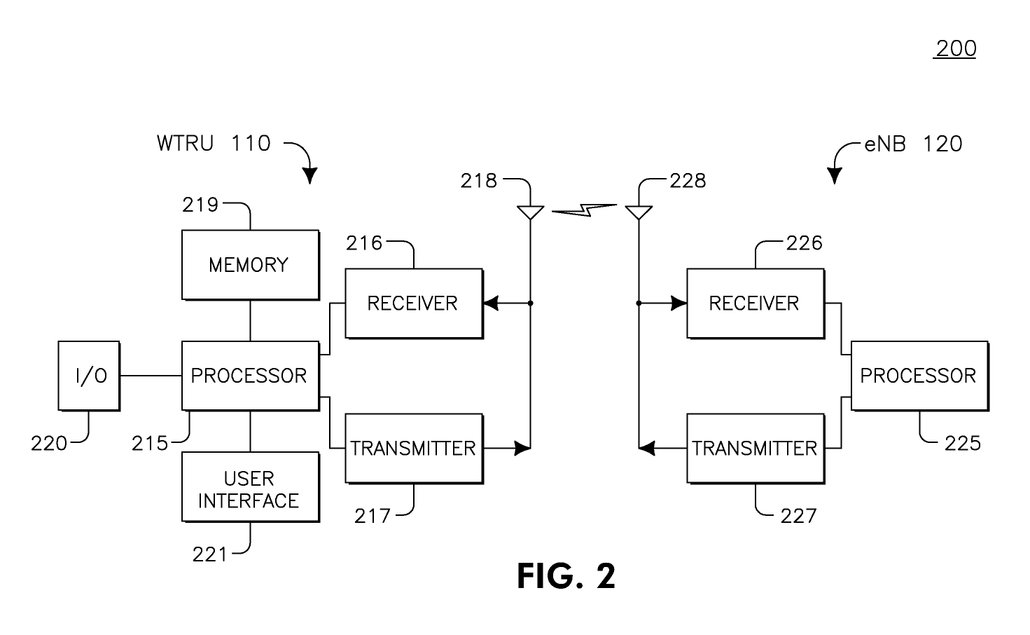

FIG. 2 is a functional block diagram 200 of a WTRU 110 and the eNB 120 of the wireless communication system 100 of FIG. 1. As shown in FIG. 1, the WTRU 110 is in communication with the eNB 120. The WTRU 110 is configured to receive system information and system information change notification from the eNB 120. The eNB 120 may be configured to transmit, and the WTRU 110 may be configured to receive on and monitor signals on the broadcast control channel (BCCH). The WTRU 110 may also be configured to operate in a discontinuous reception (DRX) mode. The WTRU 110 may be configured to receive paging messages and other radio resource control (RRC) messages.

In addition to the components that may be found in a typical WTRU, the WTRU 110 includes a processor 215, a receiver 216, a transmitter 217, and an antenna 218. The WTRU 110 may also include a user interface 221, which may include, but is not limited to, an LCD or LED screen, a touch screen, a keyboard, a stylus, or any other typical input/output device. The WTRU 110 may also include memory 219, both volatile and non-volatile as well as interfaces 220 to other devices, such as universal serial bus (USB) ports, serial ports and the like. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical eNB, the eNB 120 includes a processor 225, a receiver 226, a transmitter 227, and an antenna 228. The receiver 226 and the transmitter 227 are in communication with the processor 225. The antenna 228 is in communication with both the receiver 226 and the transmitter 227 to facilitate the transmission and reception of wireless data.

When a WTRU is in connected state, it may be functioning in a continuous mode or a discontinuous reception (DRX) mode. In a continuous mode, the WTRU is communicating with the eNB on continuous basis. This may occur, for example, when a user is performing a file transfer or talking to another user. Alternatively, when a user is not actively communicating with the eNB, the WTRU may move into DRX mode. In DRX mode, the WTRU cycles into an “off” state on a periodic basis. This may save battery usage and prevent unnecessary signaling. The WTRU may then cycle into an “on” mode to check to see if there are any signals for it. While the WTRU is “on”, it can look for a system information change notification by monitoring a communication channel for a paging message. The paging message is transmitted from the eNB and may contain a system information change notification.

When the WTRU is in DRX mode, it turns off and on based on a DRX cycle, which may be different than the eNB's system information change notification cycle. The WTRU may align the DRX cycle's on-duration and the active period time with the eNB system information change notification cycles or use the DRX cycle's on-duration and active period to acquire other system information notification occasions and receive the system information change notification by checking a downlink channel, such as the physical downlink control channel (PDCCH). This may allow the WTRU to receive a system information change indicator while it is in an on-duration and active time cycle. This may avoid wasting WTRU power. Likewise, the eNB may also distribute the transmission of the system information change notifications often enough to allow the WTRU DRX cycle on-duration and active time to overlap or be in close proximity to the system information change notification cycle.

The system information change indication cycle may be determined by the equation N=C×DRXL (EQUATION 1), where N is the system information change notification cycle in frames, C is an integer constant, and DRXL is the length of the cycle when the WTRU is in DRX mode, also measured in frames. If C is a small integer, the system information change indication cycle will be relatively close to the DRX length. If the eNB transmits a system information change notification once every DRX cycle (C=1), or every 2 DRX cycles (C=2), it may be easier for the WTRU to align the DRX on-duration with a system information change notification occurrence than if C where a larger number. The eNB may choose the longest allowable DRXL as a default value in the formula as a starting point, or a DRXL value may be chosen that saves a maximum amount of power in the WTRU.

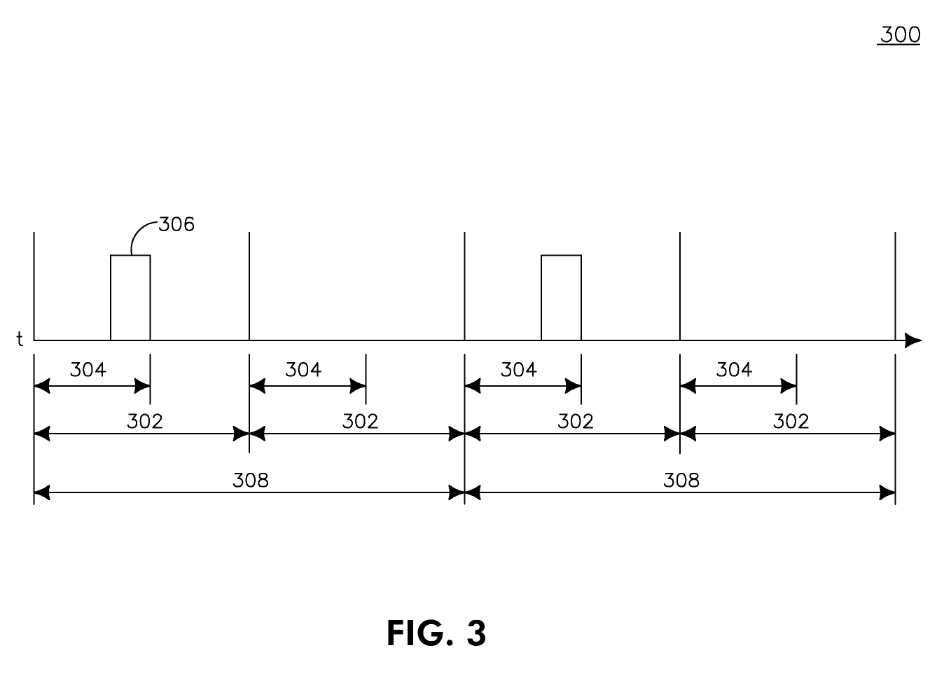

FIG. 3 shows a method of system information change notification 300 in accordance with one embodiment. As shown in FIG. 3, a system information change notification indicator 306 may be received while a WTRU is in connected state. The WTRU is in DRX mode with a DRX period 302 and an on-duration 304. The system information change notification indicator 306 is received during the on-duration 304. The system information change notification period 308 is twice that of the DRX period 302, and is set up to coincide with the DRX period 302. With reference to EQUATION 1, for FIG. 3, C=2.

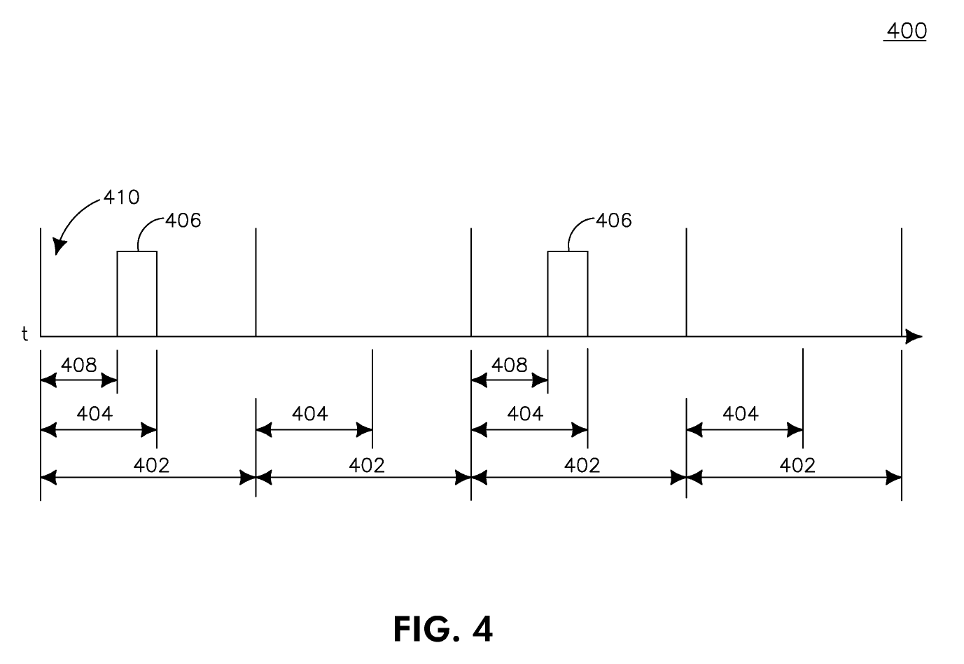

FIG. 4 shows a method for system information change notifications 400 in accordance with another embodiment. At the beginning of a first frame 410 of a DRX period 402, a WTRU may be receiving control signaling on a downlink channel, such as the physical dedicated control channel (PDCCH) for example. In order for the system information change indicator 406 to not interfere with other signaling over the PDCCH, the system information change indicator 406 may be offset from the beginning of the first frame 410 of the DRX period. The timing offset (X) 408 is measured from the beginning of the frame 410 to the system information change notification indicator and may insure that the system information change notification indicator 406 does not collide with other PDCCH control signaling. X 408 is the offset with respect to the beginning of the frame 410 where the DRX period on-duration 404 begins. X 408 may be in units of sub-frames, and X 408 may be less than or equal to the on-duration 404 of the DRX period 402 or less than or equal to the DRX active-time, wherein DRX active-time is the DRX on-duration plus the time the WTRU is monitoring downlink channels. X 408 may be the offset from the start of the DRX cycle 410 or may be an offset from the start of the control signaling (not shown), which may also be offset.

The system frame number (SFN) of the frame carrying the system information update indicator, if using an offset, may be calculated by SFN mod N=X div 10, where X is the offset in sub-frames counted from the beginning of the DRX on-duration and N is the system information change notification cycle in frames.

Once the frame number is determined, the sub-frame number of the sub-frame in which the indicator may be located may be determined by X mod 10. The association between the system information change notification period and the WTRU DRX mode cycle length assumes that the DRX length setting is per cell.

The method and apparatus disclosed herein may be used with static and/or semi-static system information and transmitted while the WTRU is in connected mode. However, the eNB may transmit dynamic system information indicators and connected mode system information change indicators on the same PDCCH. In order to avoid conflict, the dynamic system information indicator sub-frame may be configured to avoid collision with the connected mode system information change indication sub-frame. For example, the dynamic system information change indicator may use a sub-frame prior to the sub-frame used for the connected mode system information change indicator. Both sub-frames may be in the same downlink frame.

Alternatively, a different radio network temporary identifier (RNTI) may be used for a connected mode system information change indicator than for a dynamic system information change indicator. A WTRU may use a first RNTI over the PDCCH to look for the dynamic system information update indicator and a second RNTI to monitor for the connected mode system information change notification, even though both the updated contents are received over the broadcast control channel (BCCH).

A system information change indicator may be transmitted on the PDCCH. The indicator may be, for example, a single bit or a bit map. If the indicator is a single bit, the bit value may be toggled when the entire system information changes. The WTRU may read a first SIB containing information about a second SIB that includes the changed parameter.

The indicator may also be a bit map. Each bit or bit group in the bit map may represent one or more particular SIBs with similar features. The bit or bit-group may indicate whether the associated SIB or SIB-group is changed. A change in an individual bit value may indicate a change in an associated SIB. A new value of a bit group may also indicate change in the associated SIB. The WTRU may avoid unnecessary SIB acquisitions that may interrupt normal WTRU operation in connected state or drain WTRU power.

If the changed SIB is not critical to a current WTRU mode of operation, the WTRU may ignore the SIB change to defer or avoid any unnecessary SIB acquisition. Also, if a particular SIB, such as the SIB-1, for example, does not change coincidentally with other SIBs, then an SIB broadcast schedule may be determined by the WTRU to be unchanged and the WTRU may use an existing SIB broadcast schedule to reacquire the changed SIBs without reading the SIB-1.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for a wireless transmit receive unit (WTRU) to receive a system information change notification, the method comprising the WTRU aligning a discontinuous reception (DRX) on-duration with a system information notification cycle.

2. The method as in claim 1 wherein the DRX period is a maximum DRX period chosen from a set of predefined DRX periods.

3. The method as in claim 1, wherein the DRX cycle provides power savings for the WTRU.

4. The method as in claim 1, further comprising the WTRU determining an offset value, wherein the system information change notification is delayed by the offset value.

5. The method as in claim 1, further comprising configuring a dynamic system information indicator to not conflict with a static or semi-static system information indicator.

6. The method as in claim 5 wherein the dynamic system information indicator and the static or semi-static system information indicator are received by the WTRU in separate sub-frames.

7. The method as in claim 1 further comprising:
the WTRU receiving a dynamic system information update notice with a first radio network temporary identifier (RNTI); and
the WTRU receiving a static or semi-static information update notice with a second RNTI.

8. The method as in claim 1, wherein the system information change notification is a single bit.

9. The method as in claim 1, wherein the system information change notification is a bit map.

10. A wireless transmit receive unit (WTRU) configured to receive system information updates, the WTRU comprising:
a receiver configured to receive system information updates and notifications of system information updates; and
a processor configured to aligning a discontinuous reception (DRX) on-duration with a system information update cycle such that the system information update cycle is a multiple of a DRX cycle.

11. The WTRU as in claim 10 wherein the DRX period is a maximum DRX period chosen from a set of predefined DRX periods.

12. The WTRU as in claim 10 wherein the DRX cycle provides power savings for the WTRU.

13. The WTRU as in claim 10 wherein the processor is further configured to determine an offset value, wherein the system information update is delayed by the offset value.

14. The WTRU as in claim 10 wherein the processor is further configured to configure a dynamic system information indicator to not conflict with a static or semi-static system information indicator.

15. The WTRU as in claim 14 wherein the processor is further configured to adjust the dynamic system information indicator and the static or semi-static system information indicator and the receiver is further configured to receive adjust the dynamic system information indicator and the static or semi-static system information indicator in separate sub-frames.

16. The WTRU as in claim 10 wherein the receiver is further configured to:
receive a dynamic system information update notice with a first radio network temporary identifier (RNTI); and
receive a static or semi-static information update notice with a second RNTI.

17. The WTRU as in claim 10 wherein the notification of system information updates is a single bit.

18. The WTRU as in claim 10 wherein the notification of system information updates is a bit map.
